(19) United States
(12) Patent Application Publication
(10) Pub. No.: US 2022/0342104 A1
(43) Pub. Date: Oct. 27, 2022

(54) DYNAMIC AND INTERACTIVE SPIRAL-SHAPED GEOLOGICAL TIME SCALES

(71) Applicant: Landmark Graphics Corporation, Houston, TX (US)

(72) Inventors: Benjamin Patrick Ivko, Abingdon (GB); Oliver Nicholas Morris, Kilburn (GB)

(21) Appl. No.: 17/761,462

(22) PCT Filed: Oct. 18, 2019
(86) PCT No.: PCT/US2019/056924

§ 371 Date: Mar. 17, 2022

(51) Int. Cl. G01V 1/48; G01V 1/46

(52) U.S. Cl. CPC G01V 1/48; G01V 1/46

(57) ABSTRACT

Displaying a spiral-shaped visualization of a geological time scale according to some aspects may include accessing a time-attributed data set representing a geological time scale of a subterranean region. The geological time scale may be segmented into a hierarchy of intervals (e.g., periods, epochs, and stages). The spiral-shaped visualization may include a path formed in a spiral formation. The path may begin at a center position of the spiral-shaped visualization and may end at an outer portion of the spiral-shaped visualization. The beginning of the path may represent a first time of the geological time scale. The ending of the path may represent a second time of the geological time scale. The spiral-shaped visualization may also be segmented to represent the hierarchy of intervals. Additionally, the spiral-shaped visualization may be interactive. Selecting an interval of the path may automatically cause the intervals of the spiral-shaped visualization to be filtered.

### TECHNICAL FIELD

The present disclosure relates generally to methods and devices used to interpret geological data sets for hydrocarbon exploration in subterranean formations. More specifically, but not by way of limitation, this disclosure relates to generating and displaying a dynamic and interactive geological time scale in a spiral-format.

### BACKGROUND

Geological time scales have historically been visualized using vertical or horizontal timelines that are represented in a linear format. Typical geological time scales, however, represent a geological history of up to 4.50 billion years. Vertical or horizontal time scales become very long and narrow. Displaying vertical or horizontal time scales or highlighting key events or time periods is challenging for devices with small screens.

Additionally, interacting with a vertical or horizontal time scale is challenging because the linear visualization cannot be displayed entirety on a single screen with any meaningful resolution. Sunburst charts have also been used to depict hierarchical data sets. Sunburst charts, however, are generally ineffective at representing a geological time scale because these charts are not structured to represent a continuous, ordered progression of time.

### BRIEF DESCRIPTION OF THE DRAWINGS

FIG. 1 is a block diagram illustrating a computing device for performing geological time scale visualizations according to some aspects.

FIG. 2 is a spiral-shaped visualization of a geological time scale according to some aspects.

FIG. 3 is an interface displaying an example of a spiral-shaped visualization of a geological time scale that can be interactive according to some aspects.

FIG. 4 is an interface displaying an example of a modified spiral-shaped visualization generated by filtering the geological time scale shown in FIG. 3 according to some aspects.

FIG. 5 is an interface displaying an example of a transformation tool for transforming between spiral and linear visualizations of the geological time scale according to some aspects.

FIG. 6 is an interface displaying an example of a geological time scale visualization in a linear format according to some aspects.

FIG. 7 is an interface displaying an example of composite time scales and a geological map for investigating potential locations of subterranean hydrocarbons according to some aspects.

FIG. 8 is a flow chart illustrating an example of a process for generating and displaying an interactive spiral-shaped geological time scale according to some aspects.

FIG. 9 is a cross-sectional side view of an example of a subterranean formation identified as a potential well system according to some aspects.

### DETAILED DESCRIPTION

Certain aspects and features of the present disclosure relate to generating an interactive spiral-shaped visualization of a geological time scale for displaying on a screen. A geological time scale may be a visual depiction of the chronology of geological strata (e.g., a series of layers of rocks in the ground). The chronology of geological strata may be determined using hierarchical data sets, which segment time intervals into periods, periods into epochs, and epochs into stages. The spiral-shaped visualization may be formed by rendering one or more paths in a spiral shape. The beginning of each path may be positioned at the center of the spiral-shaped visualization, and the end of each path may be positioned at an outer edge of the spiral-shaped visualization. The beginning of a path can represent the earliest time on the geological time scale, and the end of the path can represent a later time (or present day) on the geological time scale (or vice versa). A path may be segmented into one or more periods. Each period of the path may be segmented into one or more epochs. Each epoch of the path may be segmented into one or more stages. Additionally, the interactive spiral-shaped visualization may enable a user to select one or more segments of a path to filter the hierarchical data sets. For example, if a user selects the Triassic period represented as an interval on the path of the spiral-shaped visualization, the remaining periods other than the Triassic period may be removed from the visualization. The selection of an interval of the path causes the hierarchical data set depicted by the spiral-shaped visualization to be automatically filtered. The interactive spiral-shaped visualization enables users to assess resources (e.g., hydrocarbons) in subterranean formations (including areas on the land surface).

In some implementations, the spiral-shaped visualization may compress a linear timeline of sequential, time-attributed geological data into a spiral shape with the center representing the older end of the timeline and the outside representing a later time or the present day (or vice versa). Further, each path of the spiral-shaped visualization may be segmented into geological time divisions (e.g., epochs). The spiral-shaped visualization may be displayed on an interface. The interface may receive input corresponding to a selection of a time interval of a path. Examples of the input can include a click received at a time interval of the spiral-shaped visualization or the selection of a time interval from a drop-down menu. The hierarchical time intervals of the spiral-shaped visualization can be filtered to display only the time intervals that match the selected interval. The remaining intervals may be removed from the visualization or otherwise inhibited from presentation. The interface may also display a selectable link (e.g., a button) that causes the spiral-shaped visualization to transform or unravel into a linear time scale when the link is selected.

In some implementations, the spiral-shaped visualization may be generated using a JavaScript component that is embedded within a webpages or an analytical platform. The spiral-shaped visualization can also be used as an interactive tool to filter time intervals of the geological time scale and visually synthesize the time-distribution of geological data sets. As an illustrative example, the entirety of a geological time scale can be depicted by the spiral-shaped visualization on a single screen. The displayed resolution of the spiral-shaped visualization may enable a user to clearly view all of the intervals of the geological time scale at the same time on the screen. Further, the spiral-shaped visualization can be dynamic because intervals of the spiral paths can be visually modified (e.g., highlighted, visually emphasized, or hidden) to depict selected or filtered geological data.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

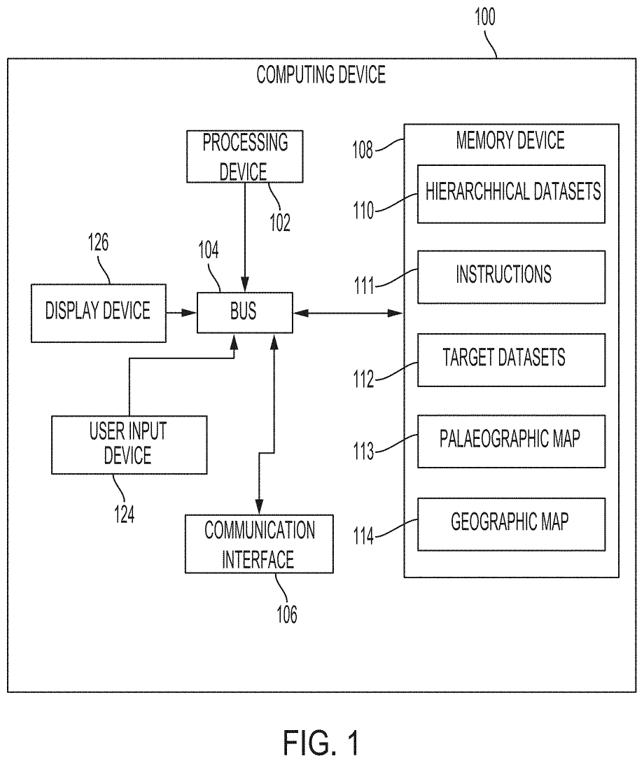

FIG. 1 depicts an example of a computing device 100 according to one example. The computing device 100 can include a processing device 102, a bus 104, a communication interface 106, a non-transitory or non-volatile memory device 108, a user input device 124, and a display device 126. In some examples, some or all of the components shown in FIG. 1 can be integrated into a single structure, such as a single housing. In other examples, some or all of the components shown in FIG. 1 can be distributed (e.g., in separate housings or in separate locations) and in wired or wireless communication with each other.

The processing device 102 can execute one or more operations for generating the spiral-shaped visualizations of geological time scale. The processing device 102 can execute instructions 111 stored in the memory device 108 that are executable by the processing device 102 to perform the operations. The processing device 102 can include one processing device or multiple processing devices. Non-limiting examples of the processing device 102 include a Field-Programmable Gate Array (“FPGA”), an application-specific integrated circuit (“ASIC”), a microprocessing device, etc.

The processing device 102 can be communicatively coupled to the memory device 108 via the bus 104. The non-volatile memory device 108 may include any type of memory device that retains stored information when powered off. Non-limiting examples of the memory device 108 include electrically erasable and programmable read-only memory (“EEPROM”), flash memory, or any other type of non-volatile memory. In some examples, at least some of the memory device 108 can include a non-transitory medium from which the processing device 102 can read instructions. A non-transitory computer-readable medium can include electronic, optical, magnetic, or other storage devices capable of providing the processing device 102 with computer-readable instructions or other program code. Non-limiting examples of a computer-readable medium include (but are not limited to) magnetic disk(s), memory chip(s), read-only memory (ROM), random-access memory (“RAM”), an ASIC, a configured processing device, optical storage, or any other medium from which a computer processing device can read instructions. The instructions can include processing device-specific instructions generated by a compiler or an interpreter from code written in any suitable computer-programming language, including, for example, C, C++, C#, etc.

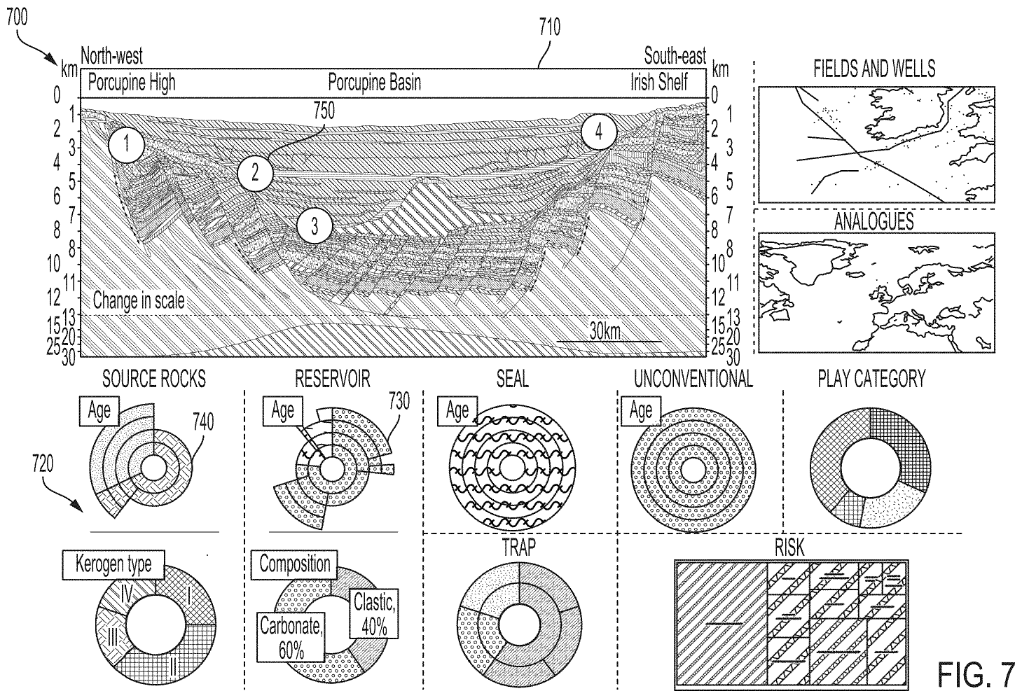

In some examples, the memory device 108 can include hierarchical data sets 110, gathered and grouped from a geochronological database or multiple geochronological databases. Hierarchical data sets may represent a chronology of events or periods of a subterranean formation or mineral ages from a specific geographical region. For example, a hierarchical data set may include a sequence of time intervals representing the chronology of geological events for a subterranean formation. Each time interval may be segmented into one or more epochs. Each epoch may be segmented into one or more stages. The memory device 108 can also include target datasets 112, gathered and grouped from one or more geochronological databases. The memory device 108 can include a stored paleogeographic map 113 and a stored geographic map 114. For example, the paleogeographic map 113 and a spiral-shaped visualization (and potentially one or more composite visualizations described herein) may be used to facilitate the exploration of hydrocarbon fluids, as shown in FIG. 7.

In some examples, the computing device 100 includes a communication interface 106. The communication interface 106 can represent one or more components that facilitate a network connection or otherwise facilitate communication between electronic devices. Examples include, but are not limited to, wired interfaces such as Ethernet, USB, IEEE 1394, and/or wireless interfaces such as IEEE 802.11, Bluetooth, near-field communication (NFC) interfaces, RFID interfaces, or radio interfaces for accessing cellular telephone networks (e.g., transceiver/antenna for accessing a CDMA, GSM, UMTS, or other mobile communications network).

In some examples, the computing device 100 includes a user input device 124. The user input device 124 can represent one or more components used to input data. Examples of the user input device 124 can include a keyboard, mouse, touchpad, button, or touch-screen display, etc.

In some examples, the computing device 100 includes a display device 126, which can render and display the spiral-shaped visualization of a geological time scale described herein and other information used in the process described herein. The display device 126 can represent one or more components used to output data. Examples of the display device 126 can include a liquid-crystal display (LCD), a television, a computer monitor, a touch-screen display, etc. In some examples, the user input device 124 and the display device 126 can be a single device, such as a touch-screen display.

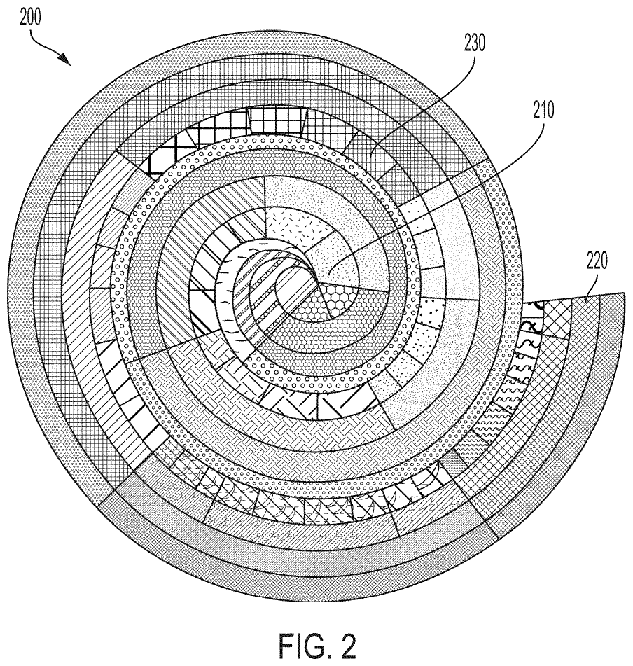

FIG. 2 depicts a graphical display of a spiral-shaped visualization 200, which represents a geological time scale according to some aspects. The spiral-shaped visualization 200 may be formed by presenting one or more paths in a spiral formation. A beginning position 210 of the path may be located at the center of the spiral-shaped visualization 200. The beginning position 210 of the path may represent the earliest time interval of the geological time scale. Alternatively, the beginning position 210 of the path may represent the latest time interval of the geological time scale. An end position 220 of the path may be located at the outer edge of the spiral-shaped visualization 200. When the beginning position 210 of the path represents the earliest time interval, then the end position 220 of the path may represent the latest time interval of the geological time scale. When the beginning position 210 of the path represents the latest time interval, then the end position 220 of the path may represent the earliest time interval of the geological time scale.

Each path of the spiral-shaped visualization 200 may represent a continuous chronology of geological time intervals for a subterranean region. In some examples, the chronology may be a logarithmic timeline. Each path may be segmented into a hierarchy of time intervals. As an illustrative example, interval 230 may be a segment of a path. Interval 230 may represent the Cretaceous period. While not shown, interval 230 may be further segmented into a plurality of epochs; specifically, a time interval for the “early” epoch and a time interval for the subsequent “late” epoch. Accordingly, the spiral-shaped visualization 200 may represent the hierarchical time intervals (e.g., periods may be segmented into epochs, which may be segmented into stages).

The segments of time intervals along a path (from the beginning position 210 to the end position 220, or vice versa) may represent sequential time intervals of the geological time scale. In some implementations, the time intervals of a path may be differentiated by color. The spiral-shaped visualization 200 may be interactive. For example, if a user moves a cursor to hover over a time interval of the spiral-shaped visualization 200, additional details of the time interval may be presented or any hidden time intervals associated with the time interval may be presented to the user. In some examples, if the user selects a time interval using the cursor, the spiral-shaped visualization 200 may be filtered.

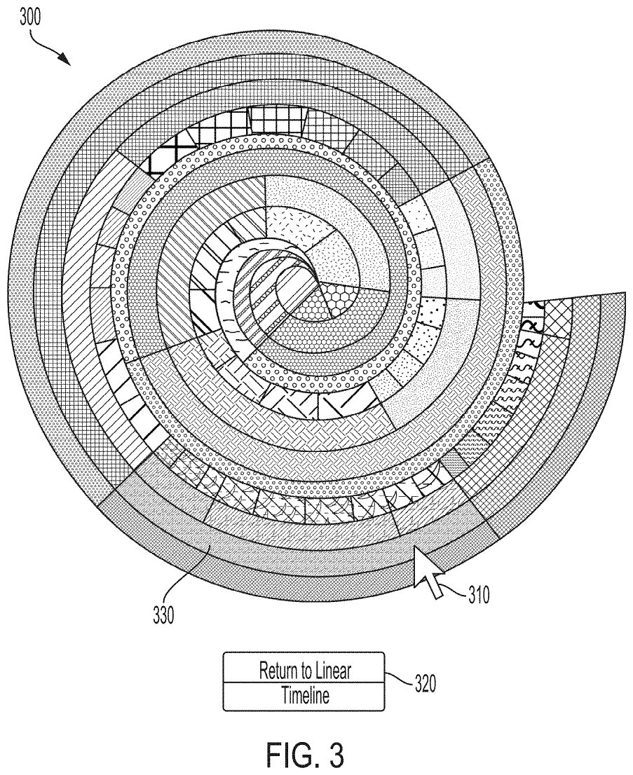

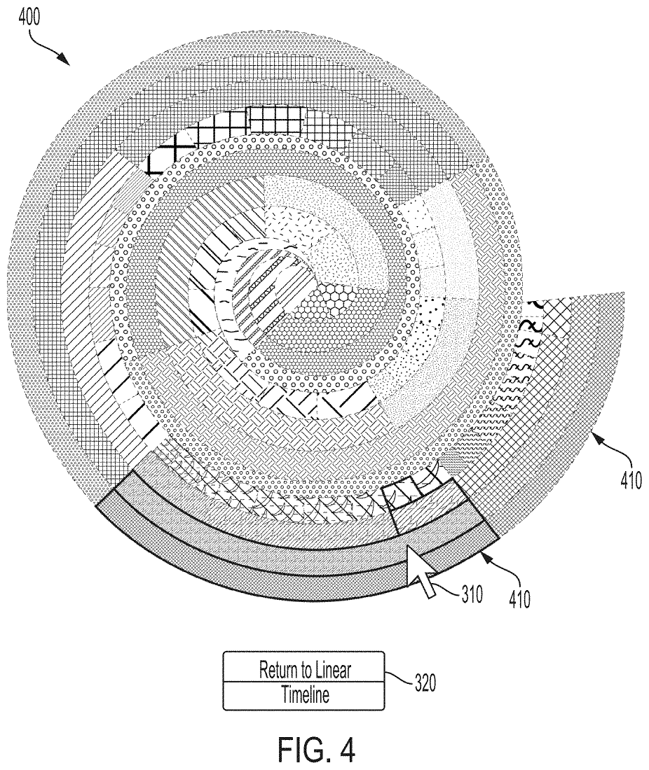

FIGS. 3-4 illustrate an example of an interface that enables a user to filter geological data sets by interacting with a spiral-shaped visualization 300. Referring to the example illustrated in FIG. 3, the interface may include the spiral-shaped visualization 300 and a transformation tool 320. The interface may receive an input, for example, using user input device 124 of FIG. 1. As an illustrative example, the spiral-shaped visualization 300 may include an interval 330 representing the Triassic period. The input may be cursor 310 clicking on the interval 330. The selection of interval 330 may be detected by processing device 102 of FIG. 1, which may retrieve metadata of the interval 330. The metadata of interval 330 may include an interval identifier (e.g., “Triassic”). The metadata, however, is not limited to the interval identifier and may be any data characterizing the interval.

The processing device 102 may also retrieve or access the hierarchical data set used to generate the spiral-shaped visualization 300. The hierarchical data set may include data representing a plurality of periods (e.g., time intervals). Each period may correspond to a plurality of epochs. Each epoch may correspond to a plurality of stages. The processing device 102 may automatically filter the hierarchical data set using the metadata of the interval 330. Filtering the hierarchical data set may result in a filtered data set. The filtered data set may be a subset of the hierarchical data set. Further, the filtered data set may include data representing segments or intervals that match the metadata of interval 330. Continuing with the above example, the filtered data set may include all intervals that are associated with the Triassic period, including eras, epochs, and stages. The filtered data set may include an interval representing the Mesozoic era, three epochs (e.g., early, middle, and late), and at least seven stages (e.g., Anisian, Ladinian, Carnian, and others). These intervals are associated with the Triassic node of the hierarchical data set.

Referring to FIG. 4, a modified version 400 of the spiral-shaped visualization 300 may be generated in response to filtering the hierarchical data set. The modified version 400 may represent the filtered data set. For example, the modified version 400 may include a visually emphasized portion 410 and a visually inhibited portion 420. The visually emphasized portion 410 may represent the filtered data set. Continuing with the example above, the visually emphasized portion 410 may represent the intervals that are associated with the Triassic period. The visually inhibited portion 420 may represent all of the remaining intervals that are not included in the filtered data set. For example, the Permian period is a separate period and not included within the Triassic period. Thus, the Permian period would not be included in the filtered data set. The Permian period would be represented within the visually inhibited portion 420.

Examples of depicting the intervals included within the visually emphasized portion 410 may include not changing the presentation of the intervals, changing a color or size of the intervals, depicting an outline around a boundary the intervals, increasing a transparency of the intervals, modifying a shading effect of an area within the intervals, modifying a texture effect of an area within the intervals, and other suitable examples. Examples of depicting the intervals included within the visually inhibited portion 420 may include removing the intervals entirely from the spiral-shaped visualization, changing a color or size of the intervals, depicting an outline around a boundary the intervals, modifying a texture effect of an area within the intervals, increasing a transparency of the intervals, modifying a shading effect of an area within the intervals, and other suitable examples.

The modified version 400 of the spiral-shaped visualization 300 can be used to efficiently depict results of filtering the hierarchical data set in response to a single interaction (e.g., a click by a cursor). While not shown in FIGS. 3-4, in some implementations, a drop-down menu may be presented on the interface concurrently with the spiral-shaped visualization 300. The drop-down menu may enable a user to select an interval from a drop-down list. When the user selects an interval (e.g., the Triassic period), the processing device 102 may filter the hierarchical data set according to the selected interval. The processing device 102 may also cause the modified version 400 of the spiral-shaped visualization 300 to be displayed on the interface.

In some implementations, the spiral-shaped visualization 200 may be displayed in any one of three states. The first state may be an unfiltered state. Available time intervals of a geological time scale can be represented, as shown in the spiral-shaped visualization 200 of FIG. 2. The second state may be a “selected” state, in which one or more time intervals of the spiral-shaped visualization are selected by the user, and the selected time intervals are visually emphasized, as in spiral-shaped visualization 400 of FIG. 4. The unselected time intervals may be visually inhibited in the “selected” state. The third state may be a “filtered” state, in which the unselected time intervals are removed from the spiral-shaped visualization. For example, the spiral-shaped visualization 400 in the “filtered” state may be displayed with visually inhibited portion 420 removed or hidden.

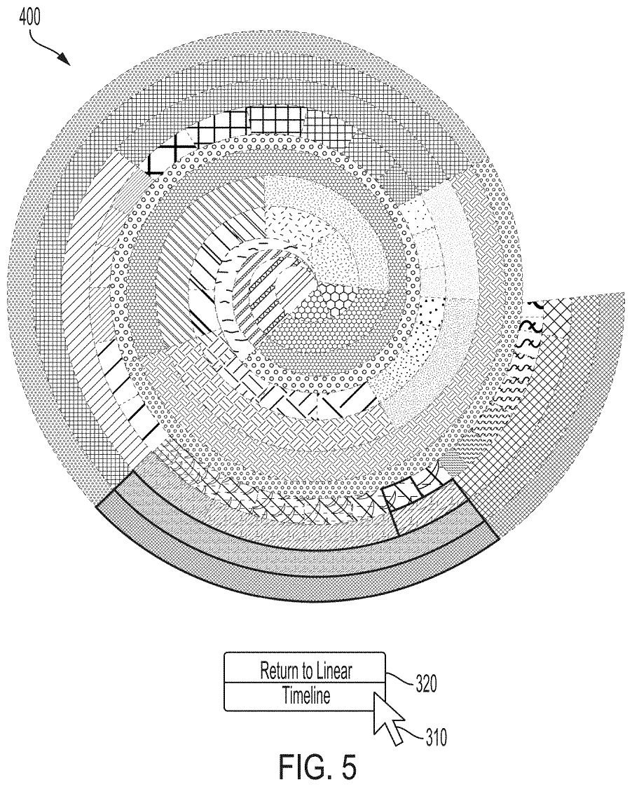

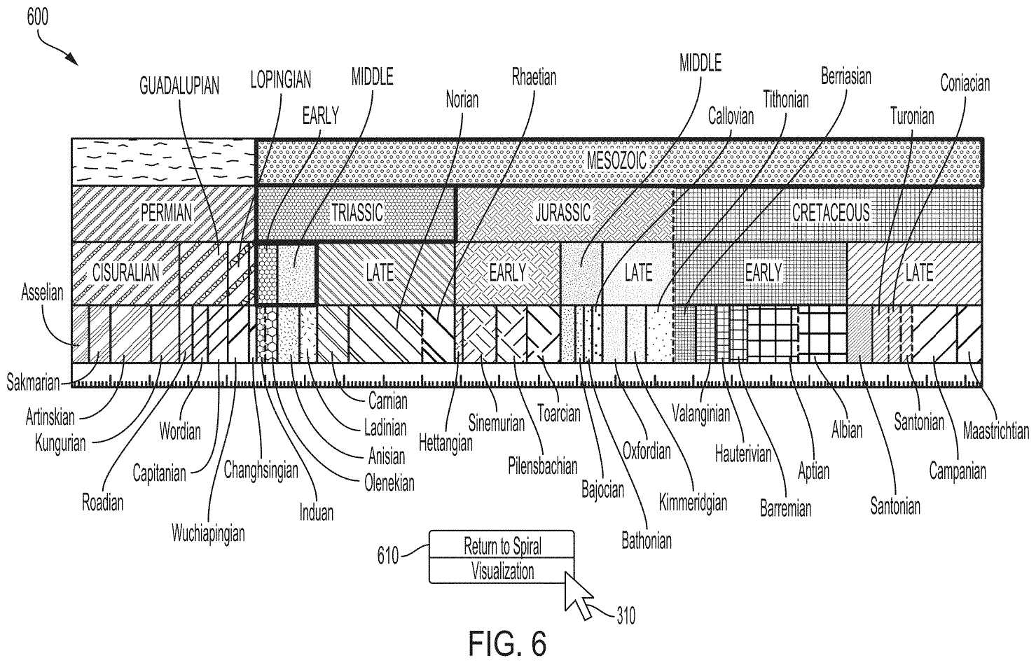

FIGS. 5-6 illustrate an example of a transformation tool 320 displayed on the interface depicted in FIGS. 3-4 according to some aspects. The transformation tool 320, when selected, may cause the spiral-shaped visualization 300 or the modified version 400 to transform from a spiral shape to a linear visualization 600 of the geological time scale (shown in FIG. 6). The user input device 124 of FIG. 1 may detect that the transformation tool 320 was selected, for example, by detecting a click or tap on a selectable button representing the transformation tool 320. The user input device 124 may communicate the detected input to the processing device 102 of FIG. 1. The processing device 102 may cause the spiral-shaped visualization 300 to transform into the linear visualization 600 of FIG. 6. In some implementations, the processing device 102 may cause a transition image or a set of transition images to be displayed on the display device 126. The transition image may visually depict to the user that the spiral-shaped visualization 300 is transforming into the linear visualization 600 of the geological time scale. As an illustrative example, the display device 126 may display a set of transition images that depict the spiral-shaped visualization 300 unraveling into the linear visualization 600 of FIG. 6. In some implementations, the processing device 102 may cause the user to navigate to a different interface that displays the linear visualization 600.

Selecting the transformation tool 320 may or may not reset any filters applied to the spiral-shaped visualization 300. In some implementations, if the transformation tool 320 is selected as shown in the example illustrated in FIG. 5, then the modified version 400 of the spiral-shaped visualization 300 may be transformed into the linear visualization 600 of the geological time scale. In this example, however, the linear visualization 600 may maintain the representation of the filtered data set. For example, the linear visualization 600 may depict each of the visually emphasized portion 410 and the visually inhibited portion 420 in a linear shape, instead of a spiral shape. As illustrated in FIG. 6, the selected portion of FIG. 5 is also shown as selected in FIG. 6 using bold lines. In some implementations, selecting the transformation tool 320 may reset any filters that were previously selected before transforming the spiral-shaped visualization 300 into the linear visualization 600. The linear visualization 600 may be segmented into a hierarchy of multiple intervals. For example, the linear visualization 600 may include an interval representing the Jurassic period. The Jurassic period is further segmented into multiple epochs (e.g., early, middle, and late).

Referring to FIG. 6, after transforming the spiral-shaped visualization 300 into the linear visualization 600, the transformation tool 320 may be automatically converted to transformation tool 610. The transformation tool 610, when selected, may cause the display device 126 to depict the transformation of the linear visualization 600 into the spiral-shaped visualization 300.

Both the spiral-shaped visualization 300 and the linear visualization 600 represent a geological time scale. The geological time scale may represent a chronology of geological events or intervals over the span of up to 4.5 billion years. In some examples, the majority of geological data may be limited to a shorter period, such as within the last 550 million years or so. Representing the geological time scale in a linear shape can result in the entire time scale not being displayed on a single screen. As the resolution increases, the portion of the linear visualization 600 that can be displayed on a single screen decreases. As the resolution decreases, the portion of the linear visualization 600 that can be displayed on the screen increases, however, the resolution becomes too small. Additionally, the linear visualization 600 can become very long and narrow. Scrolling through the linear visualization 600 to identify a target interval can be time consuming and tedious.

The spiral-shaped visualization 300, however, can enable the user to view the entire geological time scale on a single screen with suitable resolution. Further, the spiral formation of the path can enable the user to view all intervals of the geological time scale without having to scroll. The spiral-shaped visualization 300 may take up a smaller area on the interface than the linear visualization 600. Additionally, the spiral-shaped visualization 300 may depict intervals for which data is missing. The spiral-shaped visualization 300 can provide efficient interaction. For example, a single click on any interval may cause the spiral-shaped visualization 300 to be filtered. Comparing two different spiral-shaped visualizations (one each for two different regions) can also be enhanced because the entire geological time scale for each region is visible on a single screen.

FIG. 7 illustrates an example of an interface 700 for exploring potential locations of subterranean hydrocarbons according to some aspects. The interface 700 may include a portion of the screen for a geological map 710 of a subterranean formation and another portion of the screen for composite time scales 720. The geological map 710 may depict the strata of the subterranean formation. The strata may include one or more different rock types. For example, the rock types may be determined by accessing well logs collected from boreholes placed around the subterranean formation. As an illustrative example, the geological map 710 may depict strata of several rock types, including source rocks, reservoir rocks, and seal rocks, which are elements in understanding potential hydrocarbon production. Exploring the subterranean formation for hydrocarbons may include evaluating the geological map 710 to identify certain conditions. Spiral-shaped visualizations according to some aspects may enhance hydrocarbon exploration by improving the visualization of resources in the subterranean formation.

The composite time scales 720 may include one or more spiral-shaped visualizations. The composite time scales 720 may include a spiral-shaped visualization for each rock type displayed in the geological map 710. For example, the composite time scales 720 may include a spiral-shaped visualization 730 representing a geological time scale of the reservoir rocks and a spiral-shaped visualization 740 representing a geological time scale of the source rocks. The spiral-shaped visualization 730 may depict a chronology of events or intervals specific to reservoir rocks within the subterranean formation. Similarly, the spiral-shaped visualization 740 may depict a chronology of events or intervals specific to source rocks within the subterranean formation. The interface 700 can display the entire geological time scale for each of the spiral-shaped visualizations 730 and 740.

Each of the spiral-shaped visualizations displayed in the composite time scales 720 may be interactive. A portion of the spiral-shaped visualization can be selected to filter the geological time scale to one or more target intervals. The geological map 710 and related data sets in the other visualizations of the composite time scales 720 may be automatically updated based on a result of the filtering (e.g., the reservoir ages of the spiral-shaped visualization 730 may be filtered to the ages that relate to the source rock ages of spiral-shaped visualization 740). As an illustrative example, the user input device 124 may detect that a cursor selected an interval representing the Triassic period from the spiral-shaped visualization 730. The user input device 124 can communicate the detected selection to the processing device 102. In response, the processing device 102 can filter all of the intervals of the spiral-shaped visualization 730 down to only the intervals that are associated with the Triassic period (e.g., the epochs and stages of the Triassic period). The processing device 102 can communicate with the display device 126 to update the interface 700 by modifying the spiral-shaped visualization 730 to depict intervals from the Triassic period, but not intervals from other periods. The modified version of the spiral-shaped visualization 730 may visually inhibit intervals of the spiral-shaped visualization 730 that do not match the Triassic period. For example, the intervals associated with the Permian period (and any other non-Triassic period) may be inhibited from presentation (e.g., removed or shaded).

In addition, the geological map 710 can also be updated based on a result of the filtering. For example, the geological map 710 can be updated to highlight or otherwise emphasize the reservoir rocks from the Triassic period. In some implementations, the geological map 710 can also be automatically updated to identify one or more candidate locations of hydrocarbons from the reservoir rocks of the Triassic period. A potential location 750 may be indicated on the geological map 710. The processing device 102 can determine the one or more candidate locations (including the potential location 750) based on conditions favorable for the formation of hydrocarbons. For example, the processing device 102 can access one or more databases that store well logs to identify locations of sandstone within the reservoir rocks of the Triassic period. The location of sandstone may indicate a favorable condition for the formation of hydrocarbons.

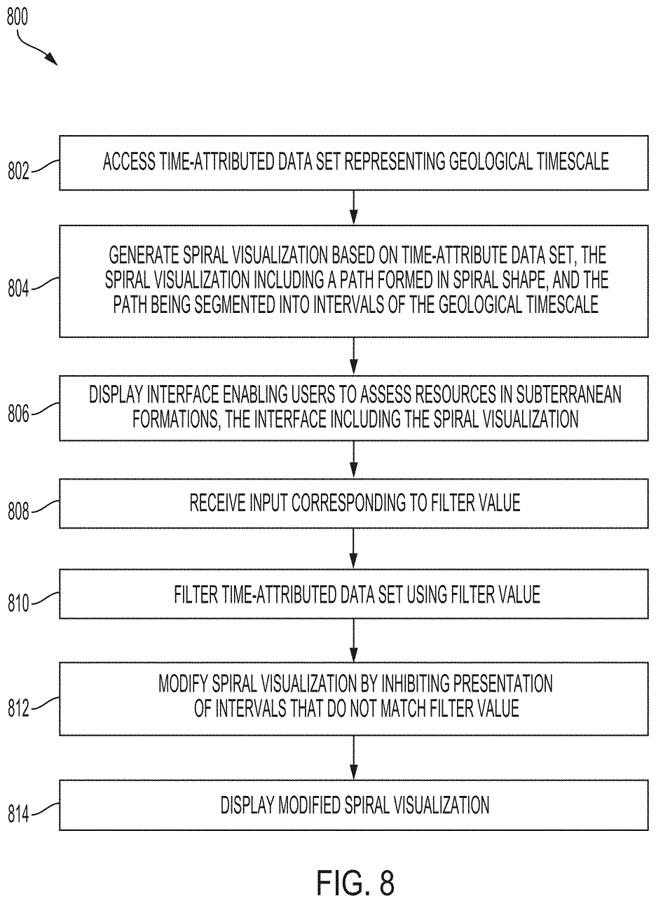

FIG. 8 is a flow chart illustrating a process 800 for generating and displaying an interactive spiral-shaped geological time scale according to some aspects. In this example, the process 800 may be performed by computing device 100 of FIG. 1. Further, performing the process 800 may cause the interactive spiral-shaped visualization of a geological time scale to be displayed on an interface. At block 802, a geological time-attributed data set may be accessed, for example, using communication interface 106 of FIG. 1. The geological time-attributed data say may represent a geological time scale of a subterranean region. The geological time scale may be segmented into a hierarchy of time intervals. For example, the geological time scale may include a time interval representing the Triassic period. The Triassic period may be segmented into the epochs: early, middle, and late. Further, each epoch may be segmented into one or more stages.

At block 804, a spiral-shaped visualization depicting the geological timescale may be generated, for example, using processing device 102 of FIG. 1. The spiral-shaped visualization may be generated based on the time-attributed data set. The spiral-shaped visualization may include a path formed in a spiral shape (as shown in FIG. 2, for example). A beginning position of the path may be located at a center position of the spiral-shaped visualization. An end position of the path may be located at an outer edge of the spiral-shaped visualization. The beginning position of the path may represent a first time of the geological timescale. The end position of the path may represent a second time of the geological timescale. In some examples, the first time is before the second time, and in other examples, the first time is later than the second time. The path may be segmented into a plurality of periods (e.g., time intervals, such as the Triassic period). Each segment of the path representing a period may be further segmented into a plurality of epochs (e.g., early, middle, and late). Each segment of the path representing an epoch may be further segmented into a plurality of stages.

At block 806, an interface may be displayed, for example, using display device 126 of FIG. 1. The interface may be for a web-based or native application. The interface may enable users to assess resources in subterranean formations. For example, assessing resources may include exploring regions for hydrocarbon fluids. The interface may present the spiral-shaped visualization generated at block 804. The spiral-shaped visualization displayed at block 806 may include the plurality of intervals of the geological time scale.

In some implementations, the spiral-shaped visualization may be interactive. For example, the time intervals that comprise the path may be selectable by the user, for example, through user input device 124. At block 808, a filter value may be received, for example, through user input device 124. The filter value may be determined by selecting one or more time intervals of the spiral-shaped visualization. The filter value may also be determined by selecting a time interval from a drop-down menu displayed on the interface. At block 810, the time-attributed data set may be filtered using the filter value, for example, using processing device 102 of FIG. 1. Filtering the time-attributed data set may include maintaining the time intervals that match the filter value as segments in the spiral-shaped visualization. Filtering the time-attributed data set may also include removing (or otherwise inhibiting presentation of) time intervals that do not match the filter value from the spiral-shaped visualization (e.g., as shown in FIG. 4).

At block 812, the spiral-shaped visualization may be modified to represent the filtered geological time-attributed data set. For example, the spiral-shaped visualization may be modified by inhibiting presentation of a time interval that does not match the filter value. For example, if the filter value is the “Permian” period, then the Triassic period may be removed from the spiral-shaped visualization because the Triassic period does not match the Permian period. At block 814, the modified spiral-shaped visualization may be displayed, for example, using the display device 126. In some implementations, the interface may also display a selectable link (e.g., a button) that can transform the spiral-shaped visualization into a linear visualization of a geological time scale.

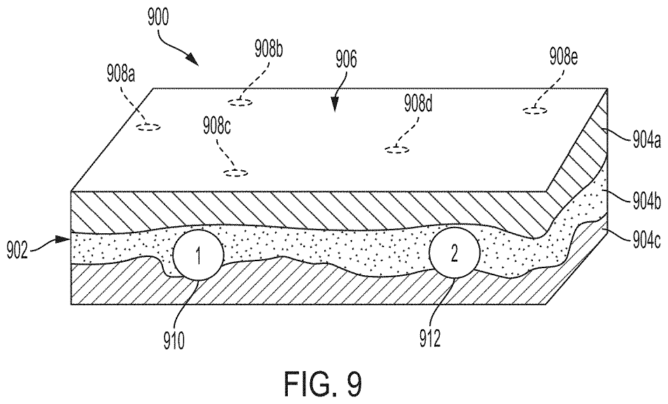

FIG. 9 is a cross-sectional side view of subterranean formation 900 identified as a potential well system according to some aspects. The subterranean formation 900 may include an underground region 902 and a surface region 906. The underground region 902 may be formed of various strata 904a-c that include different materials (e.g., rock, soil, oil, water, or gas) and vary in thickness and shape. A chronology of events that occur within the subterranean formation 900 may be visually depicted by a spiral-shaped visualization of the geological time scale, as described in implementations above. The chronology of events may be defined by the hierarchical data sets that are used to generate the spiral-shaped visualization of the geological time scale.

Chronological events that occur within the subterranean formation 900 may be predictive of the presence of hydrocarbons. The spiral-shaped visualization of the geological time scale described above may be evaluated automatically or manually by a user to explore the subterranean formation 900 for potential locations of hydrocarbons. As an illustrative example, source rocks that formed during the Permian period may be a potential source of hydrocarbons. By selecting the Permian period of a spiral-shaped visualization (e.g., the spiral-shaped visualization 300 of FIG. 3), other time intervals of the spiral-shaped visualization may be removed from the spiral-shaped visualization. Removing time intervals that do not match the selected interval (e.g., the Permian period) from the spiral-shaped visualization may clearly depict portions of the geological time scale that correspond to the Permian period. The processing device 102 of FIG. 1 may identify the regions 910 and 912 as source rock from the Permian period (e.g., by analyzing well logs for the subterranean formation 900), and thus, may label the regions 910 and 912 as potential locations of hydrocarbons because source rock can include hydrocarbons. Candidate locations 908a-e for wellbores may be identified as part of the exploration for hydrocarbon fluids.

The computing device 100 can display (using display device 126) the spiral-shaped visualizations as two-dimensional (2D) or three-dimensional (3D) figures. The spiral-shaped visualization of the geological time scale can display, for example, up to 4.5 billion years of geological data on a single screen with a suitable resolution. One example of such a visualization is shown in FIG. 2. And, multiple spiral-shaped visualizations representing geological time scales of different areas can be compared to efficiently explore subterranean formations for the presence of hydrocarbons. One example of such a visualization is shown in FIG. 7.

In some aspects, spiral-shaped visualizations of geological time scales can be generated according to one or more of the following examples. As used below, any reference to a series of examples is to be understood as a reference to each of those examples disjunctively (e.g., “Examples 1-4” is to be understood as “Examples 1, 2, 3, or 4”).

Example 1 is a computer-implemented method comprising: accessing, by a computing device, a time-attributed data set representing a geological time scale of a subterranean region, the geological time scale being segmented into a hierarchy of one or more time intervals, and each time interval of the one or more time intervals corresponding to a time period of the geological time scale; generating, by the computing device, a spiral visualization that depicts the geological time scale, the spiral visualization being generated based on the time-attributed data set, the spiral visualization including a path formed in a spiral shape, such that a beginning position of the path represents a first time of the geological time scale and an end position of the path represents a second time of the geological time scale, and the path being segmented into the one or more time intervals; and displaying, by the computing device, an interface that enables a user to assess resources in subterranean formations, the interface presenting the spiral visualization including the one or more time intervals of the geological time scale, and the one or more time intervals being selectable to filter the time-attributed data set and display a modified version of the spiral visualization based on the filtering.

Example 2 is the computer-implemented method of example(s) 1, further comprising: receiving input corresponding to a filter value; filtering the time-attributed data set using the filter value; modifying the spiral visualization by inhibiting presentation of at least one time interval of the one or more time intervals of the path, the at least one time interval that is inhibited from presentation corresponding to a time interval that does not match the filter value; and displaying the modified spiral visualization on the interface.

Example 3 is the computer-implemented method of example(s) 1-2, wherein receiving the input includes receiving a selection of a time interval of the one or more time intervals of the path; and using the selected time interval as the filter value.

Example 4 is the computer-implemented method of example(s) 1-3, further comprising: displaying a drop-down menu on the interface, wherein receiving the input includes receiving a selection of a time interval of the one or more time intervals using the drop-down menu; and using the selected time interval as the filter value.

Example 5 is the computer-implemented method of example(s) 1-4, further comprising: concurrently displaying a subterranean cross-section of the subterranean region and the spiral visualization on the interface, the subterranean cross-section including a visual indicator corresponding to a time interval of the one or more time intervals that matches the filter value, and the visual indicator being located at a position representing a potential location of hydrocarbons within the subterranean region.

Example 6 is the computer-implemented method of example(s) 1-5, further comprising: concurrently displaying a selectable button and the spiral visualization on the interface; receiving input corresponding to a selection of the selectable button; and in response to receiving the input, transforming the spiral visualization into a linear visualization of the geological time scale, the transformation causing the path to transform from the spiral shape to a straight line representing the linear visualization of the geological time scale.

Example 7 is the computer-implemented method of example(s) 1-6, further comprising: determining that a portion of the one or more time intervals is missing; and displaying the spiral visualization, such that at least one time interval of the path corresponding to the missing portion of the one or more time intervals are not presented.

Example 8 is a computer-program product tangibly embodied in a non-transitory machine-readable storage medium, including instructions configured to cause a data processing apparatus to perform operations including: accessing a time-attributed data set representing a geological time scale of a subterranean region, the geological time scale being segmented into a hierarchy of one or more time intervals, and each time interval of the one or more time intervals corresponding to a time period of the geological time scale; generating a spiral visualization that depicts the geological time scale, the spiral visualization being generated based on the time-attributed data set, the spiral visualization including a path formed in a spiral shape, such that a beginning position of the path represents a first time of the geological time scale and an end position of the path represents a second time of the geological time scale, and the path being segmented into the one or more time intervals; and displaying, by the computing device, an interface that enables a user to assess resources in subterranean formations, the interface presenting the spiral visualization including the one or more time intervals of the geological time scale, and the one or more time intervals being selectable to filter the time-attributed data set and display a modified version of the spiral visualization based on the filtering.

Example 9 is the computer-program product of example(s) 8, wherein the operations further comprise: receiving input corresponding to a filter value; filtering the time-attributed data set using the filter value; modifying the spiral visualization by inhibiting presentation of at least one time interval of the one or more time intervals of the path, the at least one time interval that is inhibited from presentation corresponding to a time interval that does not match the filter value; and displaying the modified spiral visualization on the interface.

Example 10 is the computer-program product of example(s) 8-9, wherein receiving the input includes receiving a selection of a time interval of the one or more time intervals of the path; and using the selected time interval as the filter value.

Example 11 is the computer-program product of example(s) 8-10, further comprising: displaying a drop-down menu on the interface, wherein receiving the input includes receiving a selection of a time interval of the one or more time intervals using the drop-down menu; and using the selected time interval as the filter value.

Example 12 is the computer-program product of example(s) 8-11, wherein the operations further comprise: concurrently displaying a subterranean cross-section of the subterranean region and the spiral visualization on the interface, the subterranean cross-section including a visual indicator corresponding to a time interval of the one or more time intervals that matches the filter value, and the visual indicator being located at a position representing a potential location of hydrocarbons within the subterranean region.

Example 13 is the computer-program product of example(s) 8-12, wherein the operations further comprise: concurrently displaying a selectable button and the spiral visualization on the interface; receiving input corresponding to a selection of the selectable button; and in response to receiving the input, transforming the spiral visualization into a linear visualization of the geological time scale, the transformation causing the path to transform from the spiral shape to a straight line representing the linear visualization of the geological time scale.

Example 14 is the computer-program product of example(s) 8-13, wherein the operations further comprise: determining that a portion of the one or more time intervals is missing; and displaying the spiral visualization, such that at least one time interval of the path corresponding to the missing portion of the one or more time intervals are not presented.

Example 15 is a graphical user interface comprising: a spiral-shaped visualization of a geological time scale for assessing resources in a subterranean region, the spiral-shaped visualization including a path formed in a spiral shape, such that a beginning position of the path represents a first time of the geological time scale and an end position of the path represents a second time of the geological time scale, the path being segmented into a hierarchy of one or more time intervals, and each time interval of the one or more time intervals being selectable to filter the geological time scale and display a modified version of the spiral-shaped visualization based on the filtering.

Example 16 is the graphical user interface of example(s) 15, further comprising: displaying a modified version of the spiral visualization by inhibiting presentation of at least one time interval of the one or more time intervals of the path, the at least one time interval that is inhibited from presentation corresponding to a time interval that does not match the filter value.

Example 17 is the graphical user interface of example(s) 15-16, wherein receiving the input includes receiving a selection of a time interval of the one or more time intervals of the path; and using the selected time interval as the filter value.

Example 18 is the graphical user interface of example(s) 15-17, further comprising: displaying a drop-down menu on the interface, wherein receiving the input includes receiving a selection of a time interval of the one or more time intervals using the drop-down menu, and wherein the selected time interval is used as the filter value.

Example 19 is the graphical user interface of example(s) 15-18, further comprising: concurrently displaying a subterranean cross-section of the subterranean region and the spiral visualization on the interface, the subterranean cross-section including a visual indicator corresponding to a time-based attribute that matches the filter value, and the visual indicator being located at a position representing a potential location of hydrocarbons within the subterranean region.

Example 20 is the graphical user interface of example(s) 15-19, further comprising: concurrently displaying a selectable button and the spiral visualization on the interface; receiving input corresponding to a selection of the selectable button; and in response to receiving the input, transforming the spiral visualization into a linear visualization of the geological time scale, the transformation causing the path to transform from the spiral shape to a straight line representing the linear visualization of the geological time scale.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A computer-implemented method comprising:
accessing, by a computing device, a time-attributed data set representing a geological time scale of a subterranean region, the geological time scale being segmented into a hierarchy of one or more time intervals, and each time interval of the one or more time intervals corresponding to a time period of the geological time scale;
generating, by the computing device, a spiral visualization that depicts the geological time scale, the spiral visualization being generated based on the time-attributed data set, the spiral visualization including a path formed in a spiral shape, such that a beginning position of the path represents a first time of the geological time scale and an end position of the path represents a second time of the geological time scale, and the path being segmented into the one or more time intervals; and
displaying, by the computing device, an interface that enables a user to assess resources in subterranean formations, the interface presenting the spiral visualization including the one or more time intervals of the geological time scale, and the one or more time intervals being selectable to filter the time-attributed data set and display a modified version of the spiral visualization based on the filtering.

2. The computer-implemented method of claim 1, further comprising:
receiving input corresponding to a filter value;
filtering the time-attributed data set using the filter value;
modifying the spiral visualization by inhibiting presentation of at least one time interval of the one or more time intervals of the path, the at least one time interval that is inhibited from presentation corresponding to a time interval that does not match the filter value; and
displaying the modified spiral visualization on the interface.

3. The computer-implemented method of claim 2, wherein receiving the input includes receiving a selection of a time interval of the one or more time intervals of the path; and
using the selected time interval as the filter value.

4. The computer-implemented method of claim 2, further comprising:
displaying a drop-down menu on the interface, wherein receiving the input includes receiving a selection of a time interval of the one or more time intervals using the drop-down menu; and
using the selected time interval as the filter value.

5. The computer-implemented method of claim 2, further comprising:
concurrently displaying a subterranean cross-section of the subterranean region and the spiral visualization on the interface, the subterranean cross-section including a visual indicator corresponding to a time interval of the one or more time intervals that matches the filter value, and the visual indicator being located at a position representing a potential location of hydrocarbons within the subterranean region.

6. The computer-implemented method of claim 1, further comprising:
concurrently displaying a selectable button and the spiral visualization on the interface;
receiving input corresponding to a selection of the selectable button; and
in response to receiving the input, transforming the spiral visualization into a linear visualization of the geological time scale, the transformation causing the path to transform from the spiral shape to a straight line representing the linear visualization of the geological time scale.

7. The computer-implemented method of claim 1, further comprising:
determining that a portion of the one or more time intervals is missing; and
displaying the spiral visualization, such that at least one time interval of the path corresponding to the missing portion of the one or more time intervals are not presented.

8. A computer-program product tangibly embodied in a non-transitory machine-readable storage medium, including instructions configured to cause a data processing apparatus to perform operations including:
accessing a time-attributed data set representing a geological time scale of a subterranean region, the geological time scale being segmented into a hierarchy of one or more time intervals, and each time interval of the one or more time intervals corresponding to a time period of the geological time scale;
generating a spiral visualization that depicts the geological time scale, the spiral visualization being generated based on the time-attributed data set, the spiral visualization including a path formed in a spiral shape, such that a beginning position of the path represents a first time of the geological time scale and an end position of the path represents a second time of the geological time scale, and the path being segmented into the one or more time intervals; and
displaying an interface that enables users to assess resources in subterranean formations, the interface presenting the spiral visualization including the one or more time intervals of the geological time scale, and the one or more time intervals being selectable to filter the time-attributed data set and display a modified version of the spiral visualization based on the filtering.

9. The computer-program product of claim 8, wherein the operations further comprise:
receiving input corresponding to a filter value;
filtering the time-attributed data set using the filter value;
modifying the spiral visualization by inhibiting presentation of at least one time interval of the one or more time intervals of the path, the at least one time interval that is inhibited from presentation corresponding to a time interval that does not match the filter value; and
displaying the modified spiral visualization on the interface.

10. The computer-program product of claim 9, wherein receiving the input includes receiving a selection of a time interval of the one or more time intervals of the path; and
using the selected time interval as the filter value.

11. The computer-program product of claim 9, further comprising:
displaying a drop-down menu on the interface, wherein receiving the input includes receiving a selection of a time interval of the one or more time intervals using the drop-down menu; and
using the selected time interval as the filter value.

12. The computer-program product of claim 9, wherein the operations further comprise:
concurrently displaying a subterranean cross-section of the subterranean region and the spiral visualization on the interface, the subterranean cross-section including a visual indicator corresponding to a time interval of the one or more time intervals that matches the filter value, and the visual indicator being located at a position representing a potential location of hydrocarbons within the subterranean region.

13. The computer-program product of claim 8, wherein the operations further comprise:
concurrently displaying a selectable button and the spiral visualization on the interface;
receiving input corresponding to a selection of the selectable button; and
in response to receiving the input, transforming the spiral visualization into a linear visualization of the geological time scale, the transformation causing the path to transform from the spiral shape to a straight line representing the linear visualization of the geological time scale.

14. The computer-program product of claim 8, wherein the operations further comprise:
determining that a portion of the one or more time intervals is missing; and
displaying the spiral visualization, such that at least one time interval of the path corresponding to the missing portion of the one or more time intervals are not presented.

15. A graphical user interface comprising:
a spiral-shaped visualization of a geological time scale for assessing resources in a subterranean region, the spiral-shaped visualization including a path formed in a spiral shape, such that a beginning position of the path represents a first time of the geological time scale and an end position of the path represents a second time of the geological time scale, the path being segmented into a hierarchy of one or more time intervals, and each time interval of the one or more time intervals being selectable to filter the geological time scale and display a modified version of the spiral-shaped visualization based on the filtering.

16. The graphical user interface of claim 15, further comprising:
displaying a modified version of the spiral visualization by inhibiting presentation of at least one time interval of the one or more time intervals of the path, the at least one time interval that is inhibited from presentation corresponding to a time interval that does not match the filter value.

17. The graphical user interface of claim 16, wherein receiving the input includes receiving a selection of a time interval of the one or more time intervals of the path; and
using the selected time interval as the filter value.

18. The graphical user interface of claim 16, further comprising:
displaying a drop-down menu on the interface, wherein receiving the input includes receiving a selection of a time interval of the one or more time intervals using the drop-down menu, and wherein the selected time interval is used as the filter value.

19. The graphical user interface of claim 16, further comprising:
concurrently displaying a subterranean cross-section of the subterranean region and the spiral visualization on the interface, the subterranean cross-section including a visual indicator corresponding to a time-based attribute that matches the filter value, and the visual indicator being located at a position representing a potential location of hydrocarbons within the subterranean region.

20. The graphical user interface of claim 16, further comprising:
concurrently displaying a selectable button and the spiral visualization on the interface;
receiving input corresponding to a selection of the selectable button; and
in response to receiving the input, transforming the spiral visualization into a linear visualization of the geological time scale, the transformation causing the path to transform from the spiral shape to a straight line representing the linear visualization of the geological time scale.
